(19) United States
(12) Patent Application Publication
(10) Pub. No.: US 2017/0160014 A1
(43) Pub. Date: Jun. 8, 2017

(54) METHOD FOR EXHAUST GAS TREATMENT, AND SYSTEM COMPRISING AN EXHAUST GAS TREATMENT DEVICE

(71) Applicant: ELEX CemCat AG, Schwerzenbach (CH)

(72) Inventor: Franz-Josef Zurhove, Waldshut-Tiengen (DE)

(73) Assignee: ELEX CemCat AG, Schwerzenbach (CH)

(21) Appl. No.: 15/316,815

(22) PCT Filed: Jun. 9, 2015
(86) PCT No.: PCT/EP2015/062779

§ 371 Date: Dec. 6, 2016

(30) Foreign Application Priority Data
Jun. 10, 2014 (DE) 10 2014 108 154.4

(51) Int. Cl. F27D 17/00; F27D 19/00; C04B 7/43; F27B 7/20; C04B 7/36

(52) U.S. Cl. CPC F27D 17/004; F27B 7/20; C04B 7/36; C04B 7/43; F27D 19/00

(57) ABSTRACT

A method for treating exhaust gas in an exhaust gas treatment device of a system may involve withdrawing exhaust gas from a processing device for mechanically and/or thermally processing an inorganic material of the system. The material to be fed to the processing device may be preheated by heat exchange with the exhaust gas. Further, a temperature of the exhaust gas entering the exhaust gas treatment device may be adjusted by adapting the exchange of heat between the exhaust gas and the inorganic material. In some examples, the exhaust gas treatment device may comprise an oxidation catalytic converter and/or a reduction catalytic converter.

The invention relates to a method for treating exhaust gas in a system comprising an exhaust gas treatment device, a processing device for mechanically and/or thermally processing an inorganic material, and a material preheater in which the material is preheated by means of heat exchange with the exhaust. The invention further relates to a corresponding system.

Such a system is used for example in the production of cement clinker. In this process, before being fed into a rotary kiln, the raw meal is preheated in a cyclone preheater that as a rule has four to six stages in a direction of flow opposite to that of the exhaust gas leaving the rotary kiln. The exhaust is generally cooled to a temperature of between 250° C. and 450° C.

Further devices can be integrated into the exhaust channel that are preferably operated at temperatures higher than these usual exhaust gas temperatures (downstream of the material preheater). In particular, these can be devices for exhaust gas treatment by means of catalytic and/or (regenerative) oxidative reduction of pollutants.

For the exhaust gas treatment device, it may be necessary to adjust the exhaust gas temperature to a range suitable for the reduction of pollutants. Such adjustment of the exhaust gas temperature upstream of the exhaust gas treatment device can be carried out by various measures, such as supplying water, using a heat exchanger to apply or remove heat, or adding another gas stream having a different temperature. For example, if it is desired to increase the exhaust gas temperature downstream of the preheater, this can be achieved by means of an additional heat supply such as an auxiliary heater, e.g. in the form of burners or a combustion chamber. However, this entails a considerable increase in structural expenditure. As a rule, moreover, only fuels that burn out rapidly and readily, such as natural gas or oil in particular and under certain conditions, coal, can be used in corresponding auxiliary heaters, which results in high fuel costs.

Based on the above prior art, the object of the invention is to provide an advantageous exhaust gas treatment method for the treatment of an exhaust gas originating from a processing device for mechanically and/or thermally processing material, and in particular from a cement clinker kiln.

This object is achieved by means of a method according to claim 1 and a system according to claim 3. Advantageous embodiments of the method according to the invention and advantageous configurations of the system according to the invention are the subject matter of the further claims and are presented in the following description of the invention.

The invention is based on the finding that an increase in the exhaust gas temperature downstream of the material preheater can also be achieved by means of increased fuel conversion in the processing device during firing. In principle, this makes it possible to dispense with an auxiliary heater or configure such a heater with reduced performance. However, the increased fuel conversion in the processing device results not only in increased temperature of the exhaust gas exiting the processing device, but increased temperatures in the processing device itself. This can be undesirable or impracticable, for example because it results in deterioration of the properties of the material, such as its handling properties, e.g. with respect to the formation of deposits or material quality. A possible countermeasure could be to preheat the material fed into the processing device to a lesser degree, with the result that it enters the processing device, for example a kiln (with or without a calcinator), at a lower temperature. The resulting greater heat transfer to the material maintains the gas temperatures in the processing device within the set limits despite the increased fuel conversion.

The basic concept of the invention is therefore to adjust the temperature of the exhaust gas to be fed to the exhaust gas treatment device by adapting the heat exchange between the exhaust and the material to be preheated without violating process-based restrictions on the material temperatures in the processing device.

Accordingly, a generic method for treating exhaust gas in an exhaust gas treatment device, wherein the exhaust originates from a processing device for mechanically and/or thermally processing an inorganic material and wherein the exhaust preheats the material to be fed to the processing device by means of heat exchange, is characterized according to the invention in that the temperature of the exhaust gas entering the gas treatment device is adjusted at least by adapting the exchange of heat between the exhaust and the material.

A system according to the invention that is suitable for carrying out a method according to the invention comprises at least one processing device for mechanically and/or thermally processing an inorganic material, an exhaust gas treatment device connected following the processing device relative to the direction of flow of the exhaust gas originating from the processing device, and a material preheater arranged between the processing device and the exhaust gas treatment device in which heat transfer from the exhaust gas to the material takes place, wherein the material preheater comprises one—or preferably a plurality of—heat exchanger stages. In particular, the processing device can be a kiln, for example for the firing of cement clinker. In addition to such a kiln, the processing device can also comprise a device for calcination (a calcinator) and/or for the addition of additional fuel. Such a system is characterized according to the invention in that a first inlet for the material is arranged, relative to the direction of flow of the material through the material preheater, upstream of a heat exchanger stage, a second inlet for the material is arranged, relative to the direction of flow of the material through the material preheater, downstream of this heat exchanger stage, and a control device is provided for distribution of the material as needed to the first inlet and the second inlet in order to influence the temperature of the exhaust gas entering the gas treatment device.

Here, the corresponding heat exchanger stage is preferably the stage that is first passed by the material flowing through the material preheater. This makes it possible to ensure that the heat exchange from the exhaust gas to the material takes place primarily in the heat exchanger stages located closer to the processing device(s). This can have a positive effect on pressure drop in the material and in a calcinator optionally connected to the material preheater.

The processing device can preferably be a kiln, such as a rotary kiln, with or without a calcinator. Also preferably, the kiln can be used for firing of cement clinker. Accordingly, the material to be treated can preferably be raw cement meal. Systems based on a similar principle from the field of the minerals industry are also included herein. An example is the processing of ores in the rotary kiln with a heat exchanger arranged upstream, with examples including vanadium ore or lime or dolomite kilns.

In particular, the material preheater can be configured in the form of a multistage cyclone preheater (e.g. having four, five, or six stages) whose structure and functions are generally known.

Particularly in cases where one wishes to prevent adaptation of the heat exchange in the material preheater from negatively affecting the temperatures in the processing device, in a preferred embodiment of the method according to the invention, such an effect of variable heat exchange in the material preheater can be compensated for by adaptation of heat generation in the processing device. For this purpose, the processing device of the system according to the invention has a heat generating device, wherein the supply of heat to the processing device (or the processed gas used therein) can be adjusted by the heat generating device using a control device.

As the heat generation in the processing device can also affect the temperature of the exhaust gas entering the gas treatment device, the two measures can be combined in order to make it possible to adjust the temperature of the exhaust to a temperature range provided for the exhaust gas treatment device without negatively affecting the temperatures in the processing device. As a result, increased supply of heat to the exhaust can be achieved by means of increased heat generation in the processing device, thus heating the exhaust to a temperature suitable for the exhaust post-treatment device, wherein the additional thermal energy can be “channeled” through the material preheater oxidation device by means of reduced heat transfer (i.e. less than the maximum heat transfer possible with the material preheater) from the exhaust gas to the material, and is thus available in the exhaust gas treatment device. This makes it possible to dispense with an auxiliary heater arranged downstream of the material preheater.

In order to achieve the highest possible conversion rate of the pollutants contained in the exhaust gas even at relatively low exhaust gas temperatures, it can be preferably provided that the exhaust gas treatment device comprises a catalytic device.

In particular, the catalytic device can comprise an oxidation catalytic converter, specifically a precious metal-containing oxidation catalytic converter, by means of which a reduction of the carbon monoxide (CO) and organic hydrocarbons (THC) contained in the exhaust gas in particular can be achieved. Additionally or alternatively, the catalytic device can also comprise a reduction catalytic converter, by means of which nitrogen oxides (NOx) in particular can be converted.

In cases where integration of both an oxidation catalytic converter and a reduction catalytic converter is provided, it is preferable for the oxidation catalytic converter to be arranged upstream of the reduction catalytic converter relative to the direction of flow of the exhaust. The catalytic devices may also be arranged in reverse order.

A target temperature range of the exhaust on entry into the oxidation catalytic converter, which can also be defined in the form of an individual temperature value, is advantageously between 150° C. and 650° C., preferably between 180° C. and 550° C., more preferably between 220° C. and 450° C., and particularly preferably between 250° C. and 390° C. In this case, the target temperature range does not have to be identical to the quantitatively defined temperature ranges, but can also constitute a portion of said range.

A target temperature range of the exhaust on entry into the reduction catalytic converter, which can also be defined in the form of an individual temperature value, is advantageously between 150° C. and 420° C., preferably between 180° C. and 400° C., and particularly preferably between 220° C. and 380° C. In this case, the target temperature range does not have to be identical to the quantitatively defined temperature ranges, but can also constitute a portion of said range.

In a further preferred embodiment of the system according to the invention, it can be provided that the control device is configured as a regulating device that (at least partly automatically) regulates the distribution of the material and/or the heat supply in the exhaust by means of the heat generating device depending on a target temperature range of the exhaust on entering the exhaust gas treatment device. Alternatively or additionally, an emission measurement upstream, inside, or downstream of the exhaust gas treatment device can also serve as a control parameter for the distribution of the material and/or the heat supply.

In an embodiment of the system according to the invention with an oxidation catalytic converter and a reduction catalytic converter downstream thereof, it can be advantageous to introduce into the exhaust a reducing agent that is used for the reactions in the reduction catalytic converter and contains ammonia in particular by means of a dosing device arranged between the oxidation catalytic converter and the reduction catalytic converter. In this way, exhaust gas that is already mixed with a reducing agent can be prevented from impinging on the oxidation catalytic converter. In particular, this makes it possible to prevent the reducing agent from being burned in the oxidation catalytic converter, which could sharply reduce the efficiency of oxidation of carbon monoxide and organic hydrocarbons.

The dosing device can preferably be configured so as to be regulable, wherein regulation is carried out depending in particular on the nitrogen oxide concentrations in the exhaust gas. These often sharply fluctuating nitrogen oxide concentrations can be determined at any point upstream of the reduction catalytic converter by means of a corresponding measuring device.

Moreover, in an embodiment of the system according to the invention with an oxidation catalytic converter and a reduction catalytic converter arranged downstream thereof, a cooling device for the exhaust can be advantageously provided between the oxidation catalytic converter and the reduction catalytic converter. This can make it possible to feed exhaust gas at a relatively high temperature to the oxidation catalytic converter arranged upstream of the reduction catalytic converter in the direction of flow of the exhaust without an accompanying undesirably high exhaust gas temperature in the reduction catalytic converter. In addition, the cooling device can also be used to make the supply to the exhaust of heat generated in the oxidation catalytic converter, particularly by the exothermal oxidation of carbon monoxide and organic hydrocarbons, reversible. The cooling device is preferably configured in such a manner that the above-described target temperature range for the exhaust on entry into the reduction catalytic converter can be achieved. In a particularly preferred embodiment, the cooling performance of the cooling device can be adjustable in order to react to varying temperatures of the exhaust gas exiting the oxidation catalytic converter. In particular, it can also be possible to regulate the cooling performance of the cooling device by means of a regulating device depending on the temperature of the exhaust on entering the reduction catalytic converter.

The cooling device can preferably comprise a dosing device for water or an aqueous solution. In this case, the cooling effect is based on the energy required for evaporation of the water or the aqueous solution that is withdrawn from the exhaust gas.

The dosing device for water or an aqueous solution can be configured integrally with a dosing device for reducing agents, i.e. an aqueous reducing agent solution can be introduced into the exhaust by a means of a combined injection device.

Advantageously, it can also be provided that the integral dosing device has no return line for the aqueous reducing agent solution from the injection device to a reservoir of the integral dosing device, as such a return line would make it more difficult to regulate dosing of the reducing agent in the water. This would prevent rapid regulation of the final dosage of reducing agents depending on the nitrogen oxide concentrations in the exhaust gas, which may vary sharply.

Preferably, it can be provided that the exhaust gas flows inside a housing from top to bottom through the oxidation catalytic converter, the reduction catalytic converter, and the dosing devices for the reducing agent, and through water or an aqueous solution. In this case, the housing can more preferably have an essentially constant cross-section.

In a further preferred embodiment of the system according to the invention, a dust removal device for the exhaust gas treatment device can also be provided, by means of which deposition of dust on elements of the catalytic device can be prevented and/or already deposited dust can be removed. This dust removal device, for example, can be in the form of a dust blower known per se, particularly a dust blower configured for use in cement processing plants. If the exhaust gas treatment device comprises a plurality of spatially separated components, e.g. an oxidation catalytic converter and a reduction catalytic converter, a dust removal device can also be provided for several or all of these components respectively.

The integration of one or a plurality of devices for dust removal into the system according to the invention can be appropriate, particularly based on the amounts of dust contained in the exhaust gas, if a dust filter is connected following the exhaust gas treatment device in the direction of flow of the exhaust. Specifically, in a so-called “high-dust” arrangement of the exhaust gas treatment device, the dust content in the exhaust gas can be up or even greater than 100 g/Nm³, at least in cases where cement clinker is fired by means of the processing device.

Alternatively or in addition to a catalytic device, the exhaust gas treatment device of the system according to the invention can comprise a device for (regenerative) thermal oxidation. In such a thermal oxidation device, the temperature required for oxidation is not decreased by a catalytic material, making said device particularly suitable for the treatment of exhaust gases containing catalyst poisons as well. The exhaust temperature required for thermal oxidation, which is approx. 800° C. for the conversion of hydrocarbons to carbon dioxide (CO₂) and water (H₂O), could in this case—as a supplement to adjustment of the temperature by means of adapted heat exchange between the exhaust and the material to be preheated and/or adapted heat generation in the processing device—also be produced by means of regenerative measures. In this case, thermal energy would be withdrawn from the exhaust gas downstream of the thermal oxidation device, and this thermal energy would then be used for additional heating of the exhaust upstream of the thermal oxidation device. For this purpose, at least two heat storage devices, preferably with ceramic storage masses, can be provided, with the exhaust gas upstream of the thermal oxidation device flowing through one of these devices and the exhaust gas downstream of the thermal oxidation device flowing through the other, and the integration thereof into the exhaust gas stream being cyclically switched. Such a system can also include additional elements for catalytic reduction or oxidation.

The temperature adjustment according to the invention for ensuring the most ideal temperature ranges of the exhaust possible can also be used, for example, in an exhaust gas treatment device for other pollutants such as sulfur.

The use of indefinite articles (“a,” “an”, “of an”, etc.), particularly in the claims and the portion of the description explaining said claims, is to be understood as such and not as the use of numerals. This use is therefore to be understood as meaning that the elements characterized in this manner are present at least once and can be present multiple times.

In the following, the invention is explained in greater detail with reference to the illustrative embodiment represented in the drawings. In the drawing,

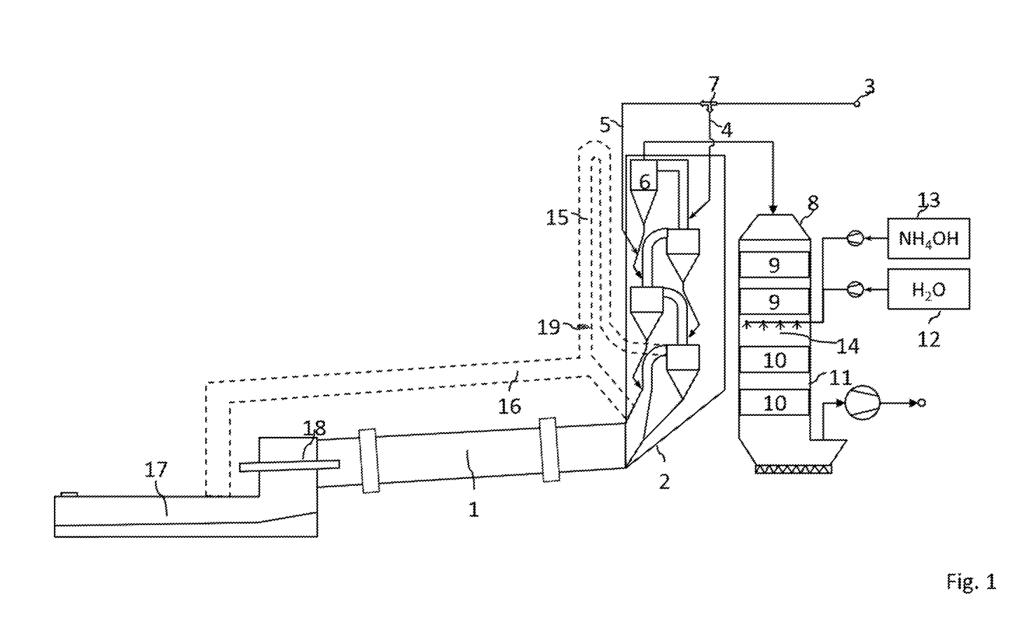

FIG. 1 shows a schematic representation of a system according to the invention.

The system shown in FIG. 1 is used for the production of cement clinker by firing raw cement meal in a processing device in the form of a rotary kiln 1. For this purpose, the finely ground raw cement meal, which comprises organic components, is dispersed in hot combustion gases originating from the rotary kiln 1 and an optionally present calcinator (15), with the organic components being expelled from the raw cement meal and incompletely burned.

A material preheater 2 in the form of a multistage cyclone preheater with an integrated calcinator 15 is arranged upstream of the rotary kiln 1 relative to the direction of flow of the material (raw cement meal or cement clinker). In the material preheater 2, exhaust gas from the rotary kiln 1 flows through the raw cement meal in a plurality of stages, the meal is carried along, and it is then re-separated from the exhaust gas stream in a cyclone of the respective preheater stage. As is common, the cyclone preheater has a vertical structure so that the raw cement meal, to the extent that it is carried along by the exhaust gas stream, is primarily moved opposite to the direction of gravity, and after separation in the cyclones, falls due to gravity into the next preheater stage. Other common types of preheating, e.g. by means of staged residence time reactors, are also possible.

The raw cement meal is fed via a raw cement meal feeder 3 into the system and supplied to the material preheater 2. In the process, the raw cement meal is distributed to a first inlet 4 arranged upstream of the first (in this case the upper) heater exchanger stage 6 relative to the direction of flow of the raw cement meal through the material preheater 2 and a second inlet 5. The raw cement meal fed via this first inlet 4 into the material preheater 2 therefore undergoes heat exchange with the exhaust gas in this first heat exchanger stage 6 (and all other heat exchanger stages). The second inlet 5 is arranged downstream of the first heat exchanger stage 6 relative to the direction of flow of the raw cement meal through the material preheater 2. The raw cement meal fed via this second inlet 5 into the material preheater 2 therefore does not undergo heat exchange with the exhaust gas in the first heat exchanger stage 6, but does undergo heat exchange in all other heat exchanger stages. If part of the raw cement meal does not pass through all of the heat exchanger stages, the total heat transfer from the exhaust gas to the material to be preheated remains below a system-specific and operating parameter-dependent maximum, which affects both the temperature of the preheated raw cement meal and the temperature of the exhaust gas exiting the material preheater 2.

The volume of the raw cement meal streams fed via the first inlet 4 and the second inlet 5 into the material preheater 2 can be adjusted as needed by means of a control device 7. This therefore allows adjustment as needed of the temperature of the exhaust gas exiting the material preheater 2, which is then fed to an exhaust gas treatment device 8 having a catalytic device. Specifically, the control device 7 is configured as a regulating device which, depending on a measured temperature of the exhaust gas entering the exhaust gas treatment device 8, regulates the volume of the raw cement meal flow fed into the material preheater 2 via the first inlet 4 and the second inlet 5 in such a way that the measured exhaust gas temperature is within a target temperature range. Here, this target temperature range is selected so as to achieve the greatest possible reduction rate of pollutants by means of a multilayer oxidation catalytic converter 9 of the exhaust gas treatment device 8.

A multilayer reduction catalytic converter 10 is arranged downstream of the oxidation catalytic converter 9 in the direction of flow of the exhaust. This is based on the principle of selective catalytic reduction of nitrogen oxides in particular. For this purpose, a reducing agent in the form of ammonium hydroxide is added to the exhaust gas in a known manner upstream of the reduction catalytic converter 10 (and downstream of the oxidation catalytic converter 9), which as a reducing agent is characterized in particular, compared to (the also possible use of) urea as a reducing agent, by a shorter evaporation path. In addition, on decomposition, urea would release carbon monoxide. In the reduction catalytic converter 10, the nitrogen oxides are reduced with ammonia to nitrogen and water, and THC components still contained in the exhaust gas are further reduced.

The oxidation catalytic converter 9 and the reduction catalytic converter 10 are integrated into the same housing 11 of the exhaust gas treatment device 8.

The temperature of the exhaust gas exiting the oxidation catalytic converter 9 is too high for long-term impingement on the reduction catalytic converter 10. This is the case in particular in exhaust gas treatment plants, whose exhaust gas contains clay minerals, anhydrite, and large amounts of calcite, as is common in the cement industry and in processing of ores. In particular, such high temperatures of the exhaust gas entering the reduction catalytic converter 10 would result in relatively rapid deactivation of the converter. The system therefore has a cooling device for the exhaust gas to be fed into the reduction catalytic converter 10. This cooling device is configured in the form of a dosing device 12 for water which is configured integrally with a dosing device 13 for ammonium hydroxide. A mixture of ammonium hydroxide and water is therefore fed via a common injection device 14 into the exhaust gas stream. The water introduced evaporates in the exhaust gas stream and thus withdraws thermal energy from said stream, resulting in a temperature decrease of the entire exhaust gas stream, which then also comprises the evaporated water and ammonium hydroxide. In this manner, the temperature of the exhaust gas entering the reduction catalytic converter 10 is preferably limited to a maximum of 380° C.

The adapted heat exchange, which in particular is also reduced compared to the maximum heat exchange performance of the material preheater 2, from the exhaust gas to the raw cement meal to be preheated affects not only the temperature of the exhaust gas entering the exhaust gas treatment device 8, but also the temperature of the raw cement meal entering the rotary kiln 1. In particular, this temperature of the preheated raw cement meal may be relatively low, but this can be compensated for by increased fuel conversion in one of a plurality of burners (18,19) of the rotary kiln 1—or if applicable—of the calcinator 15 that serve as heat generating devices. In this case, the fuel conversion and thus the heat supplied to the rotary kiln 1 and present in the exhaust can be adjusted by means of a control device or regulated by means of a regulating device. The temperature of the exhaust gas entering the exhaust gas treatment device 8 can constitute a control parameter for fuel conversion. Alternatively or additionally, other parameters can also serve as control parameters, for example a gas temperature in the optionally present calcinator 15 of the system.

In the calcinator 15, precalcining of the raw cement meal already preheated in the cyclone preheater can be carried out, and the meal is then completely fired in the rotary kiln 1 to produce cement clinker. Exhaust gas withdrawn from the rotary kiln 1 (and heated cooling air from a clinker cooler 17 arranged downstream of the rotary kiln 1 (relative to the direction of flow of the cement clinker)), which are fed to the calcinator 15 via a tertiary air line 16, are used for heating and deacidification of the raw cement meal during precalcining in the calcinator. Here, separation of material precalcined in the calcinator 15 from the exhaust gas or the cooling air takes place in the cyclone of the last heat exchanger stage of the material preheater 2.

### REFERENCE NUMBERS

1 Rotary kiln
2 Material preheater
3 Raw cement meal feeder
4 First inlet
5 Second inlet
6 First heat exchanger stage
7 Control device
8 Exhaust gas treatment device
9 Oxidation catalytic converter
10 Reduction catalytic converter
11 Housing
12 Dosing device for water
13 Dosing device for ammonium hydroxide
14 Injection device
15 Calcinator
16 Tertiary air line
17 Clinker cooler
18 Burner
19 Burner

1.-19. (canceled)

20. A method for treating exhaust gas in an exhaust gas treatment device of a system, the method comprising:
withdrawing the exhaust gas from a processing device of the system for at least one of mechanically or thermally processing an inorganic material;
preheating the inorganic material to be fed to the processing device by heat exchange with the exhaust gas; and
adjusting a temperature of the exhaust gas entering the exhaust gas treatment device by adapting the heat exchange between the exhaust gas and the inorganic material.

21. The method of claim 20 further comprising adjusting the temperature of the exhaust gas entering the exhaust gas treatment device by adapting heat generation in the processing device.

22. A system comprising:
a processing device for at least one of mechanically or thermally processing an inorganic material;
an exhaust gas treatment device following the processing device relative to a direction of flow of the exhaust gas originating from the processing device;
a material preheater disposed between the processing device and the exhaust gas treatment device in which heat transfer from the exhaust gas to the inorganic material occurs, wherein a first inlet for the inorganic material is disposed upstream of a heat exchanger stage of the material preheater relative to a direction of flow of the inorganic material through the material preheater, wherein a second inlet for the inorganic material is disposed downstream of the heat exchanger stage of the material preheater relative to the direction of flow of the inorganic material through the material preheater; and
a control device for distributing the inorganic material between the first inlet and the second inlet to influence a temperature of the exhaust gas entering the exhaust gas treatment device.

23. The system of claim 22 wherein the processing device includes a heat generating device, with a heat supply from the heat generating device is adjustable by way of a control device.

24. The system of claim 23 wherein the control device is configured as a regulating device that regulates at least one of the distribution of the inorganic material or the heat supply to the exhaust gas from the heat generating device depending on a target temperature range for the exhaust gas entering the exhaust gas treatment device.

25. The system of claim 22 wherein the material preheater is configured as a cyclone preheater.

26. The system of claim 22 wherein the exhaust gas treatment device comprises a catalytic device.

27. The system of claim 26 wherein the catalytic device comprises at least one of an oxidation catalytic converter or a reduction catalytic converter.

28. The system of claim 27 wherein the temperature of the exhaust gas entering the oxidation catalytic converter of the exhaust gas treatment device is between 150° C. and 650° C.

29. The system of claim 27 wherein the temperature of the exhaust gas entering the reduction catalytic converter of the exhaust gas treatment device is between 150° C. and 420° C.

30. The system of claim 27 wherein the oxidation catalytic converter is disposed upstream of the reduction catalytic converter with respect to the direction of flow of the exhaust gas.

31. The system of claim 30 further comprising a dosing device for a reducing agent disposed between the oxidation catalytic converter and the reduction catalytic converter.

32. The system of claim 30 further comprising a cooling device for the exhaust gas disposed between the oxidation catalytic converter and the reduction catalytic converter.

33. The system of claim 32 wherein the cooling device comprises a dosing device for water or an aqueous solution.

34. The system of claim 30 further comprising:
a dosing device for a reducing agent disposed between the oxidation catalytic converter and the reduction catalytic converter; and
a cooling device for the exhaust gas disposed between the oxidation catalytic converter and the reduction catalytic converter, wherein the cooling device comprises a dosing device for water or an aqueous solution,
wherein the dosing device for the reducing agent and the dosing device for water or the aqueous solution are configured integrally as an integral dosing device.

35. The system of claim 34 wherein the integral dosing device has no return line for a mixture comprising water and reducing agents from an injection device to a reservoir of the integral dosing device.

36. The system of claim 22 further comprising a dust removal device for the exhaust gas treatment device.

37. The system of claim 22 further comprising a dust filter for the exhaust gas that is positioned directly upstream or directly downstream of the exhaust gas treatment device in the direction of flow of the exhaust gas.

38. The system of claim 22 wherein the exhaust gas treatment device comprises a device for thermal oxidation.

39. A system comprising:
a processing device for at least one of mechanically or thermally processing an inorganic material;
an exhaust gas treatment device downstream of the processing device;
a material preheater that is disposed between the processing device and the exhaust gas treatment device and includes at least one heat exchanger stage, wherein heat transfer from the exhaust gas to a portion of the inorganic material occurs in the at least one heat exchanger stage of the material preheater; and
a control device for controlling the portion of the inorganic material that is fed through the at least one heat exchanger stage of the material preheater to influence a temperature of the exhaust gas entering the exhaust gas treatment device.
